(19) United States
(12) Patent Application Publication
(10) Pub. No.: US 2010/0329539 A1
(43) Pub. Date: Dec. 30, 2010

(54) SYSTEM AND METHOD FOR INSPECTING A COMPOSITE COMPONENT

(75) Inventors: Benjamin T. Blaine, Eagle, ID (US); Kristopher Ryan Okelberry, Nampa, ID (US); Joanna Davis, Germantown, MD (US); Tasche L. Streib, Boise, ID (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser NR Company, Federal Way, WA (US)

(21) Appl. No.: 12/494,703

(22) Filed: Jun. 30, 2009

(51) Int. Cl. G06K 9/00; H04N 7/18

(52) U.S. Cl. 382/141; 348/92

(57) ABSTRACT

The present disclosure includes a system for inspecting a manufactured composite component. In some embodiments, the system includes an inspection assembly having master camera assembly and a slave camera assembly. The master camera assembly and the slave camera assembly each include a machine vision camera and a lighting system. The lighting assembly may include back lights and spot lights. In some embodiments, the master camera and the slave camera are each connected to a telecentric lens. The composite component is inspected by moving it through the inspection assembly, taking images, and processing the images to measure features on the component.

### TECHNICAL FIELD

The present disclosure is directed generally to systems and methods for inspecting a manufactured wood component using a machine vision system.

### BACKGROUND

There is a widespread need in many manufacturing industries for inspection systems which can quickly verify the quality of manufactured parts without interfering with production. One popular inspection method which has been used in recent years is machine vision. Machine vision refers to the automated analysis of an image to determine characteristics of objects and other features shown in the image. Machine vision systems commonly utilize digital cameras and image processing software to inspect moving parts on an assembly line without stopping production or involving human workers. Examples of industries commonly employing machine vision inspection techniques include manufacturers of semiconductor chips, automobiles, food and pharmaceuticals. Methods of using machine vision systems in these and other applications are described, for example, in U.S. Pat. No. 7,308,127, U.S. Pat. No. 5,909,494, and U.S. Pat. No. 5,974,169, all of which are hereby incorporated by reference.

The wood products industry has a need for an improved inspection method for quality assurance and quality control. Many wood products (e.g., trusses, joists, beams, braces, columns, furniture, framing, wooden architecture, kitchenware, boats, giftware, cabinetry) are commonly made from wood components whose geometric dimensions must be within an allowable range of variation in order for the components to fit together to make the product. In addition, the surface quality often varies between different wood components. Some components may exhibit voids, feathering from machine processes, or other defects which affect the quality of the final product.

The wood products manufacturing industry does not conventionally employ machine vision for inspection purposes. Currently manual inspection methods are used to inspect the features of components of wood products. According to these methods, the component must be removed from the manufacturing line and inspected by a human through visual means or with the aid of measurement tools such as calipers. This can be a very time consuming and also does not always produce repeatable or reproducible results due to differences in pressure applied between different people or variations between tools. Other methods used include metal-based dies or gauge keys, which must be custom made for each part to be inspected.

One reason that the wood products industry has not adopted machine vision inspection is that many wood products are made from wood components which do not have a homogeneous composition. Machine vision inspection methods are typically used to gauge machined parts with precise features that are made from homogeneous materials such as steel, aluminum, or plastic. Machine vision may also be used for counting pills or measuring whether a container is full. Generally known applications of machine vision technology all include homogeneous material. In contrast, many wood components are produced from composite materials such as oriented strand board, oriented strand lumber, laminated strand lumber, parallel strand lumber, and other similar materials. Voids and other non-uniform properties associated with these wood composites can result in inconsistent measurements which interfere with the reliability and repeatability of machine vision inspection. In addition, the dusty environment in which wood products are produced can also pose a challenge for obtaining consistent measurements.

Thus, there is a need to develop an inspection method for use in wood products manufacturing that improves upon the conventional manual inspection method. More specifically, there is a need to develop machine vision inspection systems and methods that can be used to gauge a composite material such as a wood product.

### SUMMARY

The following summary is provided for the benefit of the reader only and is not intended to limit in any way the invention as set forth by the claims. The present disclosure is directed generally towards systems and methods for inspecting a manufactured wood component using a machine vision system.

In one embodiment, the disclosure includes a system for inspecting a manufactured composite component. The system includes an inspection assembly having master camera assembly and a slave camera assembly. The master camera assembly and the slave camera assembly may each include a machine vision camera and a lighting system. The lighting assembly may include one or more back lights and/or one or more spot lights. In some embodiments, the master camera and the slave camera are each connected to a telecentric lens. These telecentric lenses may be useful in measuring features on the composite component on multiple planes. In some embodiments, the telecentric lenses are each equipped with a light filter configured to filter ambient light.

Further aspects of the disclosure are directed towards methods for inspecting a composite component. In some embodiments, the composite component is moved through the inspection assembly described above. The composite component is then illuminated and the master and slave camera each acquire images of the component. The images are then processed to measure features on the composite component. In some examples, the planes can be non-parallel. In some examples, the features do not have to be the same focal length from the camera.

### BRIEF DESCRIPTION OF THE DRAWINGS

The present disclosure is better understood by reading the following description of non-limitative embodiments with reference to the attached drawings wherein like parts of each of the figures are identified by the same reference characters, and are briefly described as follows:

FIG. 1 is an isometric view of an example of a wood product that can be gauged according to embodiments of the disclosure;

FIG. 2 is a schematic view of a known wood product manufacturing process;

FIG. 3 is an isometric view of a wood component that can be inspected according to systems and methods of the disclosure;

FIG. 4 is a side view of the wood component from FIG. 3;

FIG. 5 is a top view of one side of the wood component from FIG. 3;

FIG. 6 is an isometric view of an inspection assembly according to embodiments of the disclosure;

FIG. 7 is an exploded view of a camera assembly according to embodiments of the disclosure;

FIG. 8 is a top view of the inspection assembly from FIG. 6;

FIGS. 9 and 10 are side views of the inspection assembly from FIG. 6;

FIG. 11 is a front view of the inspection assembly from FIG. 6;

FIG. 12 is a back view of the inspection assembly from FIG. 6;

FIGS. 13-15 are charts summarizing measurements of three groups of ten components made with inspection systems and methods according to embodiments of the disclosure compared to the same measurements taken with manual inspection methods;

FIG. 16 is a graph depicting the percent study variation for inspection systems and methods according to embodiments of the disclosure compared with manual inspection methods; and

FIG. 17 is a graph depicting the percent of variance per tolerance for systems and methods according to embodiments of the disclosure compared with manual inspection methods.

### DETAILED DESCRIPTION

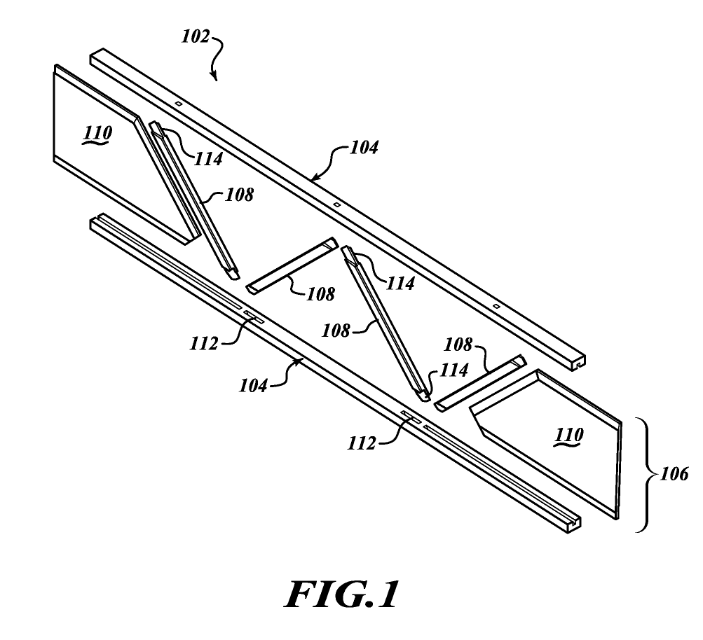

The present disclosure describes systems and methods for inspecting a manufactured wood component using a machine vision system. Certain specific details are set forth in the following description and FIGS. 1-17 to provide a thorough understanding of various embodiments of the disclosure. Well-known structures, systems, and methods often associated with such systems have not been shown or described in details to avoid unnecessarily obscuring the description of various embodiments of the disclosure. In addition, those of ordinary skill in the relevant art will understand that additional embodiments of the disclosure may be practiced without several of the details described below.

In this disclosure, the term “wood” is used to refer to any organic material produced from trees, shrubs, bushes, grasses or the like. The disclosure is not intended to be limited to a particular species or type of wood. The term “composite” is used to refer to any non-homogeneous material. The term “wood composite” is a non-homogeneous material made from wood, a cellulosic composite material (e.g., wood plastic composites, wood glass composites, wood ceramic composites) or wood strand material (e.g., oriented strand board, oriented strand lumber, laminated strand lumber, parallel strand lumber, and other similar composites). Systems and methods according to the disclosure may be used with any machined or manufactured composite components having features even if such components do not involve wood. The term “wood component” is used to refer to a component made from wood or a wood composite. The term “wood product” is used to refer to a product made using one or more wood components.

FIG. 1 shows a truss 102, which is one example of a wood product which may be used with inspection systems and methods according to the disclosure. Although FIG. 1 and many examples in the specification describe applying the systems and methods of the disclosure to wood components used in trusses, the disclosure is not intended to be limited to inspecting components for truss manufacturing or even wood components. Systems and methods according to the disclosure may be applied, for example, during the manufacture of joists, beams, braces, columns, or other wood products known to those of ordinary skill in the art. In addition, systems and methods according to the disclosure may also be applied to products made from a single wood component (e.g., wooden tools or carvings). In addition, systems and methods according to the disclosure may be used for inspection of non-wood components. Finally systems and methods according to the disclosure may be applied to non-wood composites.

In some embodiments, the truss 102 is composed of two wood components: chord elements 104 and a web 106. The web may include, for example, web elements 108 and end blocks 110, which are integrally connected to form the truss 102. The chord elements 104 include cutouts 112 (often called “mortises”) to receive an interlocking pair of tenons 114. The chord elements 104, web elements 108, and end blocks 110 may be constructed from various wood composite materials. Those of ordinary skill in the art will appreciate that in order for all the components to fit together and form a sufficiently stable truss, all of the features of the components including dimensions of notches, grooves, bevels, tapers, dovetails, fingers, and other joinery features must be within a certain tolerance.

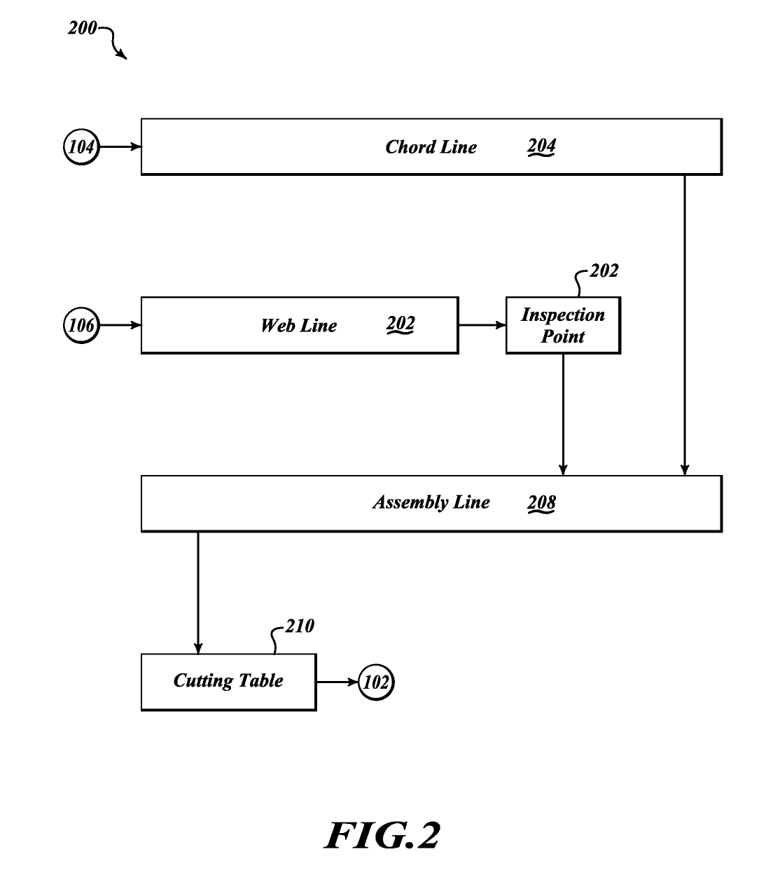

FIG. 2 shows a schematic view of a known wood product manufacturing process for manufacturing a wood component such as the truss 102. According to the Figure, the web elements 106 are produced by a web production line 202 and the chord elements 104 are produced by a chord production line 204. At an inspection point 206, the web elements 106 are removed from the web production line 202 and inspected using conventional techniques. Subsequently, the web elements 106 and the chord elements 104 are assembled on an assembly line 208 and trimmed on a cutting table 210 to produce the truss 102.

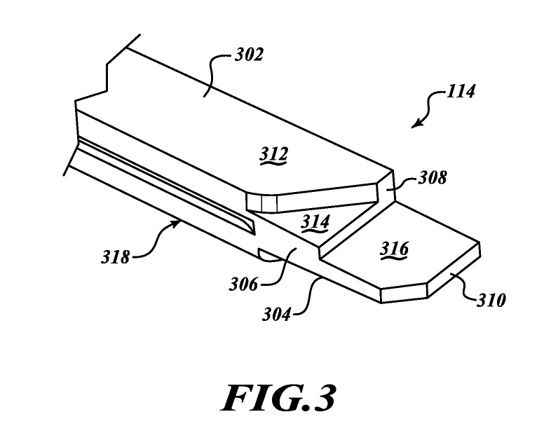

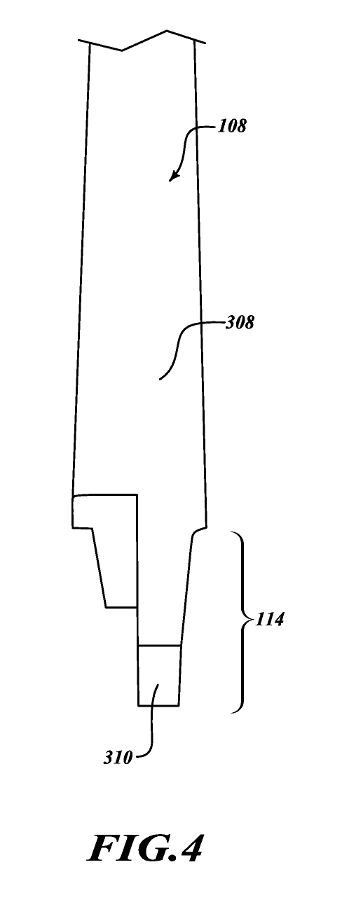

The web elements 108 are an example of a wood component which could be inspected during production to ensure that the dimensions are within the specified tolerance. FIG. 3 is an isometric view of one of the web elements 108 having a tenon 114. As shown, the tenon 114 has six primary faces: a top face 302, a bottom face 304, two side faces 306 and 308, a front face 310, and a back face which is not visible in the Figure. The tenon 114 is cut in such a way that features of the tenon 114 (e.g., notches, grooves, bevels, tapers, etc.) are located in one of five planes: a first plane 312, a second plane 314, a third plane 316, a fourth plane located on the bottom face 304 which is not visible in the drawing, and a fifth plane 318. The planes may be parallel or non-parallel. In this specific example the first plane 312 and the fifth plane 318 are not parallel; however, it should be noted that systems and methods according to the disclosure are not limited to inspecting features on this specific number or configuration of planes. FIG. 4 is a side view of the web element 108 showing the tenon 114, one of the side faces 308 and the bottom face 304.

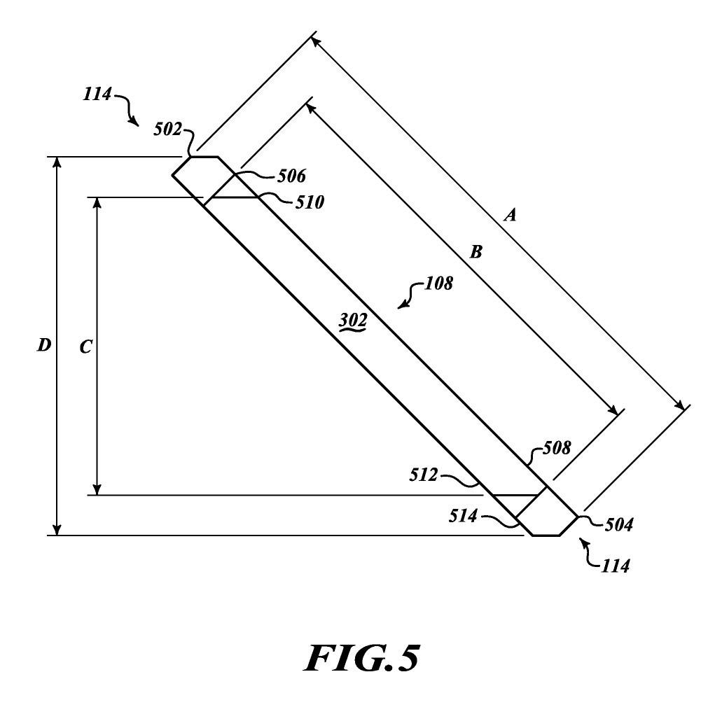

FIG. 5 illustrates some examples of features of the web element 108 on the tenons 114 which may be inspected during manufacturing. For example, it may be useful to gauge an A-dimension (shown as reference character A), a B-dimension (shown as reference character B), a C-dimension (shown as reference character C), and a D-dimension (shown as reference character D) of the tenon 114. FIG. 5 is a top view of the tenons 114 on each end of the web element 108 showing the top face 302 and the tenon position on the web element 108. The A-dimension A is the distance between point 502 and point 504. The B-dimension B is the distance between point 506 and point 508. The C-dimension C is the distance between point 510 and point 512. The D-dimension D is the distance between point 502 and point 514. In addition to the dimensions shown, one of ordinary skill in the art will appreciate that it may be useful to inspect a number of other features of the tenon 114 or other wood components according to embodiments of the disclosure.

In embodiments of the disclosure, the web element 108 or another wood component may be inspected in-line by placing an inspection assembly on the production line. Referring back to FIG. 2, for the case of the tenon 114, an inspection assembly can be placed, for example, on the web production line 202. In some embodiments, every web element 108 produced may be inspected. In other embodiments, only a sample of components are inspected. Performing inspection in-line allows the web element 108 to be inspected without stopping production or removing the web element 108 from the production line.

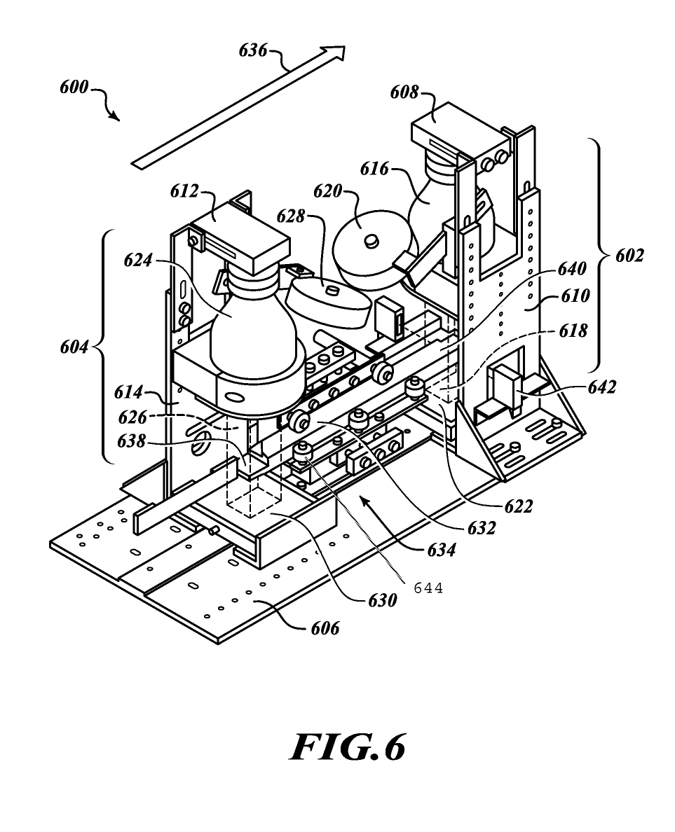

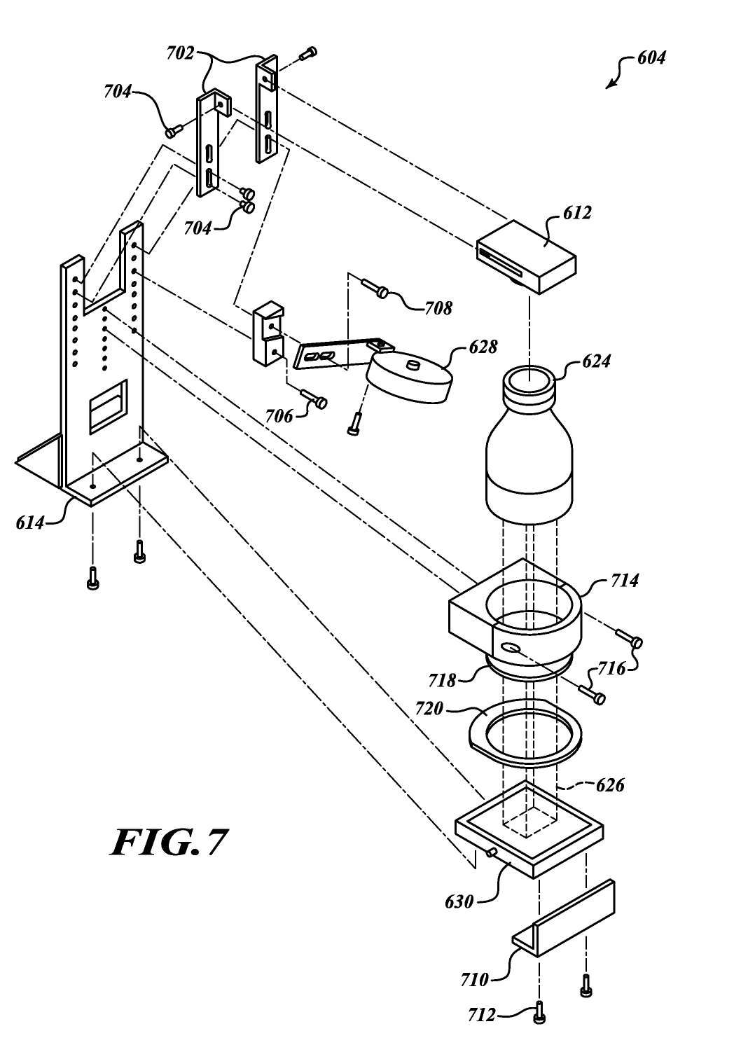

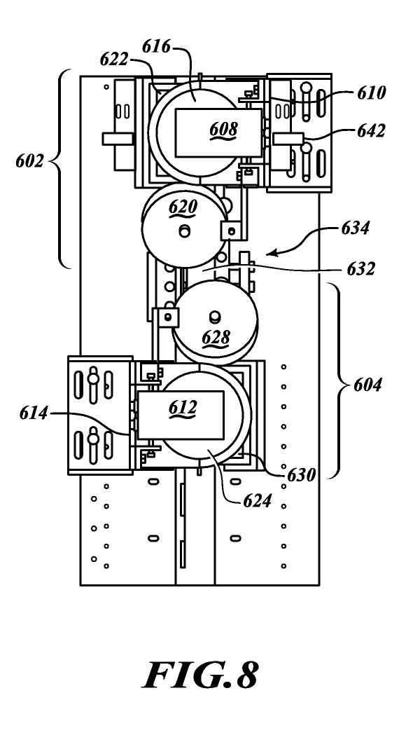

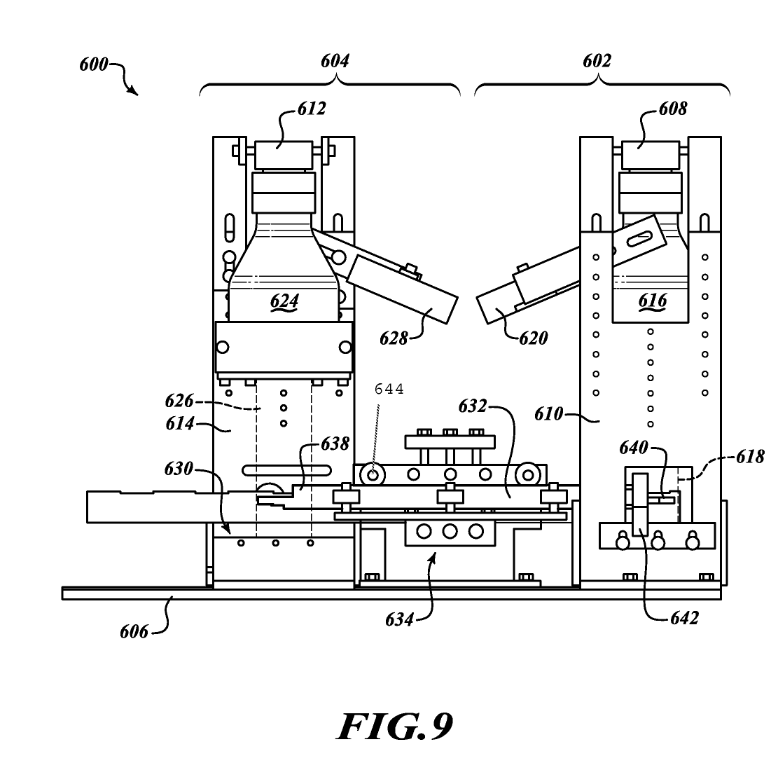

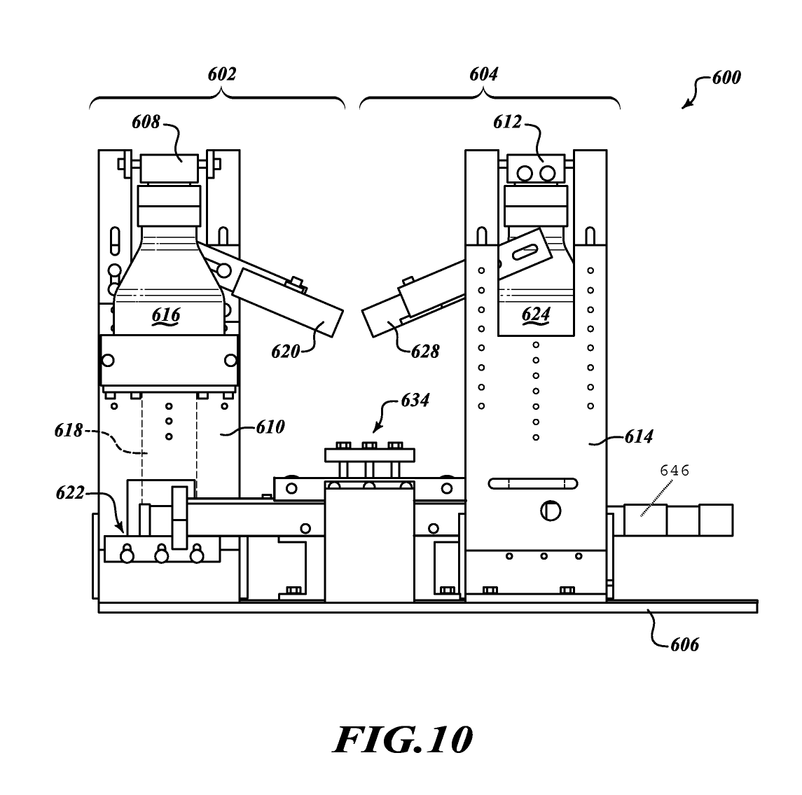

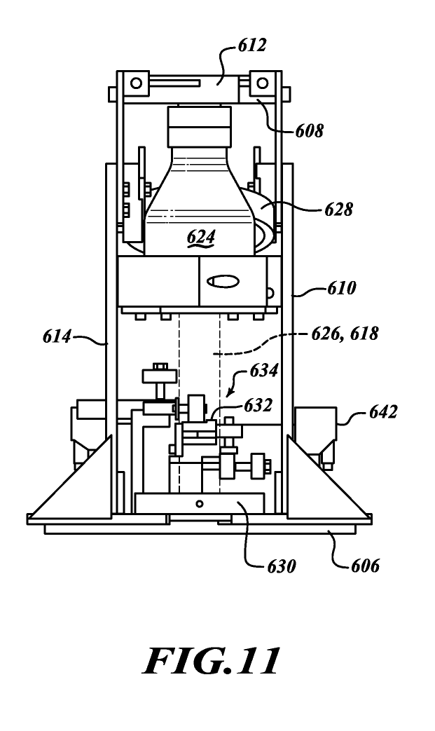

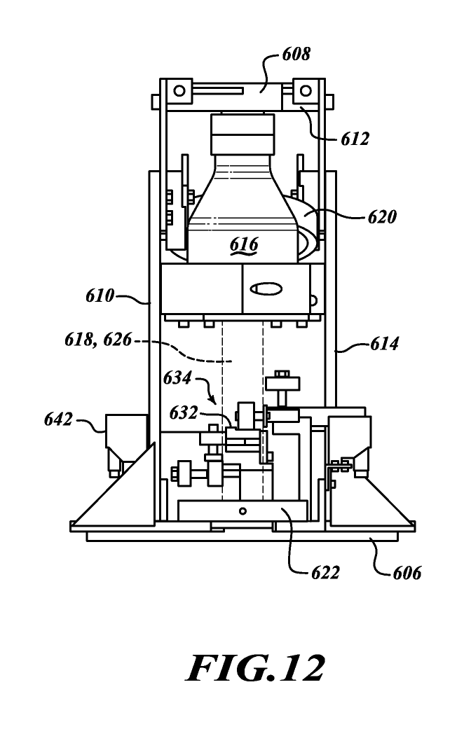

FIGS. 6-12 show examples of an inspection assembly 600 according to embodiments of the disclosure. FIG. 6 is an isometric view of the inspection assembly 600. FIG. 7 is an exploded view and FIG. 8 is a top view. FIGS. 9 and 10 are side views. FIG. 11 is a front view and FIG. 12 is a back view.

Referring FIGS. 6-12, the inspection assembly 600 includes a master camera assembly 602 and a slave camera assembly 604. The master camera assembly 602 and the slave camera assembly 604 may be mounted on a base plate 606 or any other fixture known to those of ordinary skill in the art. In some embodiments, the master camera assembly 602 and the slave camera assembly 604 are arranged in a plane that is substantially parallel to the base plate 606. FIG. 6 shows master camera assembly 602 is placed a fixed distance away from the slave camera assembly 604. In some embodiments, the fixed distance is adjustable so that the inspection assembly 600 may be used to gauge parts of varying sizes. Although FIGS. 6-12 show on example of a possible configuration for the master camera assembly 602 and slave camera assembly 604, other configurations are envisioned.

The master camera assembly 602 includes a master camera 608 attached to a mount 610 or equivalent fixture. Similarly, the slave camera assembly 604 includes a slave camera 612 attached to a mount 614 or equivalent fixture. The master camera 608 and the slave camera 612 may be digital vision cameras or any other type of camera suitable for use in machine vision systems. As shown in FIG. 6, in some embodiments, the master camera 608 is positioned such that it is facing a plane that is perpendicular to the base plate. The slave camera 612 may be positioned a fixed distance away and turned approximately 180 degrees about an axis perpendicular to the base plate 606. The cameras may also be positioned in other configurations for different applications.

The master camera 608 and the slave camera 612 each have an internal processor (not shown). The master camera 608 and the slave camera 612 function in a typical master-slave relationship known to those of ordinary skill in the art. Thus, the master camera 608 has a clocking system which instructs the slave camera 612 to take an image. Both the cameras obtain images simultaneously; however, the processor in the master camera 608 executes all calculations necessary for image processing. The calculations may then be exported to a material handling system (not shown) which may reject a component having unacceptable features or allow a component having acceptable features to remain in production.

In addition to the master camera 608, the master camera assembly 602 includes a telecentric lens 616 configured to focus the master camera's field of view 618. The telecentric lenses 616 are effective to aid in measuring features on multiple planes. In some embodiments, the master camera assembly 602 also includes a lighting system. The lighting system is effective to aid in measuring composite materials. In some embodiments, the lighting system includes a spot light 620 and a back light 622. The slave camera assembly 604 is configured in a similar manner including a telecentric lens 624 for minimizing the slave camera's field of view 626, and a lighting system, which may include a spot light 628 and a back light 630.

FIG. 7 shows an exploded view of the slave camera assembly 604. Although not shown in exploded detail, the master camera assembly 602 is configured in substantially the same manner with substantially the same components as illustrated in the Figure. Referring to FIG. 7, the slave camera 612 may be attached to the mount 614 with a pair of adjustment devices 702 and bolts 704. The adjustment devices 702 enable the slave camera 612 to move up and down longitudinally to be positioned at various locations on the mount 614. Changing the position of the slave camera 612 enables a single inspection assembly 600 to be used to measure components of different sizes. The spot light 628 may be attached to the mount 614 with a light mount 706 and bolts 708. The backlight 630 may be connected to the base plate 606 (not shown in this Figure) with a backlight mount 710 and bolts 712.

The slave camera 612 is connected to the telecentric lens 624 and both pieces may be attached to the mount 614 with a lens clamp 714 and bolts 716. . The telecentric lens 624 may be equipped with a light filter 718 coupled to the telecentric lens 624 by a lens support 720. As discussed above, the telecentric lens 624 changes the size and focus of the slave camera's field of view 626. In some embodiments, the field of view may be approximately 1200 by 1600 pixels. The inspection system 600 may be calibrated so that this is equivalent to a size of about 1.60 inches by 2.13 inches. Other configurations and calibrations are also possible within the scope of the disclosure.

In operation, inspection systems 600 according to embodiments of the disclosure may be placed in-line on a production line of a component 632. In FIGS. 6-12, the component 632 shown is a web element such as the web element 108 having tenons 114 from the previous example; however, inspection systems 600 according to the disclosure may be used for many different kinds of components having many different shapes. Components 632 may also be made from various kinds of materials; however, some inspection systems 600 according to the disclosure work particularly well with composite materials.

In some embodiments, a drive assembly 634 feeds the component 632 into the inspection assembly 600 in a direction indicated by an arrow 636. The component 632 has a front end 638 and a back end 640. As the front end 638 of the component 632 passes into the master camera's field of view 618, a triggering mechanism 642 is tripped. In this example, the triggering mechanism 642 is a photoelectric switch; however, any type triggering mechanism known to those of ordinary skill in the art may be used. Tripping of the photoelectric switch 642 triggers the lighting system to illuminate the component 632 and the cameras to take an image of the component 632.

The lighting system may be configured for specific frequencies based on the application. In some embodiments, the light filter 718 is configured to filter the light produced from the back lights 622 and 630 and the spot lights 620 and 628. For example, if the spot lights 620 and 628 and back lights 622 and 620 are configured to be green lights having a specific frequency, the light filter 718 may be configured to filter light of approximately the same frequency. Thus, the ambient light is filtered. Green light does not have to be used and is merely mentioned as an illustration. Lighting systems configured in this manner are expected to produce a white contrast around the component 632. Additionally using a strobe for the spot lights 620 and 628 is expected to create shadows around features of interest. The cameras may be configured to sense dramatic transitions between black and white; therefore, the white contrast behind the component 632 and the shadows on the features may help sharpen the imagers obtained. Although the configuration described above has shown to be useful in some applications, other configurations utilizing different lights with different frequency ranges are envisioned.

Each camera receives at least one image of both the front end 638 and the back end of the component 632. In some embodiments, all measurements are completed within 200-400 miliseconds The images are processed by an image processor such as machine vision software. The processed images enable gauging of features on the component 632 such as dimensions, notches, grooves, bevels, and tapers. [Insert datum bar details here] According to some embodiments, the features may be located within the master camera's field of view 618, the slave camera's field of view 626 or between the master camera's field of view 618, and the slave camera's field of view. The features may be located on multiple sides of an object and/or on multiple planes. The planes may be parallel or non-parallel. The features are also not required to be the same focal length away from the inspection assembly 600.

Systems and methods according to embodiments of the disclosure may be used in-line on the production line for the component 632, thereby eliminating the need to stop production for inspection. This may lead to significant cost and time savings. Samples of manufactured products may be set aside for inspection or each individual component may be inspected. In addition, systems and methods according to embodiments of the disclosure are completely automated. Thus, human interaction is not required and human error can be avoided.

From the foregoing, it will be appreciated that the specific embodiments of the disclosure have been described herein for purposes of illustration, but that various modifications may be made without deviating from the disclosure. For example, the master camera assembly and slave camera assembly may be adjusted for taking images of a particular component in a particular application. This may include adjustments to the lighting system. Additional lights may be used, different combinations of lights may be used, or no lighting may be used at all.

Aspects of the disclosure described in the context of particular embodiments may be combined or eliminated in other embodiments. For example, some embodiments of the disclosure may involve a lighting system having a back light and a spot light. Other embodiments of the disclosure may include only one of these elements, a different configuration of these elements, none of these elements, or equivalents of these elements known to those of ordinary skill in the art.

Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### EXAMPLE

To evaluate systems and methods according to the disclosure, thirty tenons were randomly selected from three production lines and inspected using both manual inspection methods and a machine vision method according to embodiments of the disclosure. Each of the three production lines represented a model size for web manufacturing. Ten components were selected from a production line for small webs (generally used to make 11⅞ joists), ten components were selected from a production line for medium webs (generally used to make 14 inch joists), and ten components were selected from a production line for large webs (generally used to make 16 inch joists).

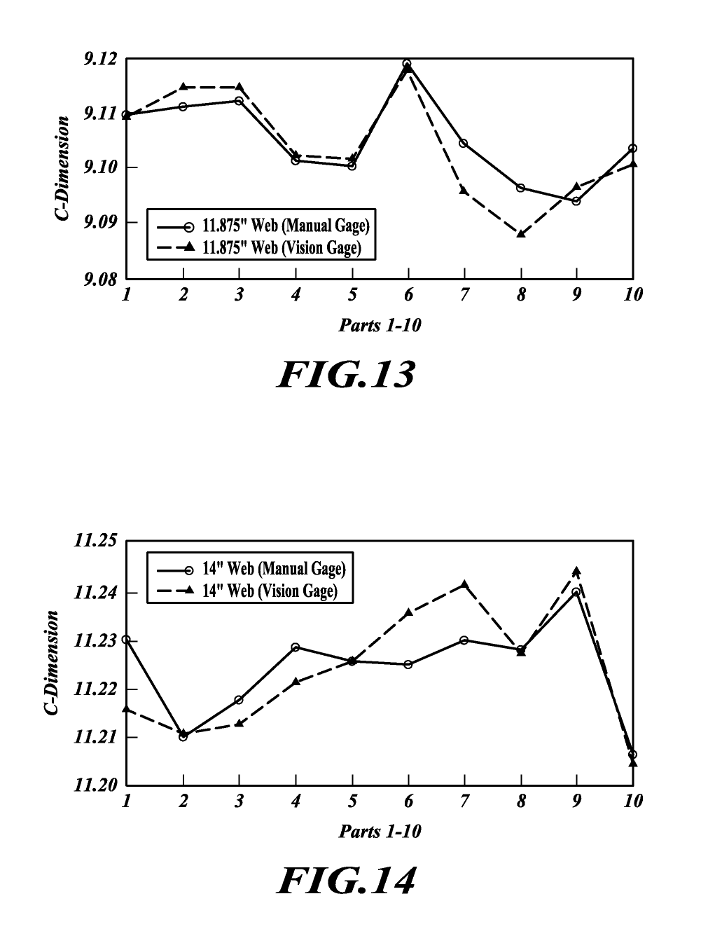

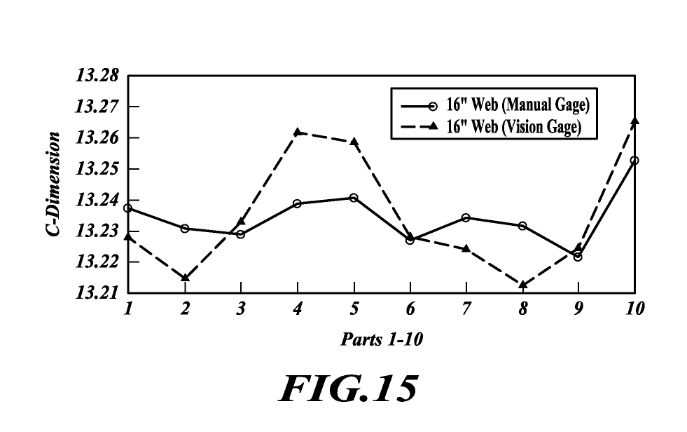

After the components were removed from the production line, each component was inspected ten times using the current manual gauge system to obtain the C-dimension C (see FIG. 5). Then each component was inspected using systems and methods according to the disclosure to obtain the C-dimension C (see FIG. 5). In this example, an inspection assembly having a lighting system including a master camera with a telecentric lens and a first light filter, a slave camera with a telecentric and a second light filter, and a lighting system was used. The lighting system included two green strobe lights and two green back lights. The data for measurements of the C-dimension C was collected and entered into a software system to evaluate the “Gage R&R” for each system. FIG. 13-15 are graphs showing the measurements obtained for each standard size of web. FIG. 13 shows the measurements for the small web, FIG. 14 shows the measurements for the medium web, and FIG. 15 shows the measurements for the large web.

Gage R&R is defined as an estimate of the combined variation of repeatability and reproducibility for a measurement system. The Gage R&R variance is equal to the sum of within-system and between-system variances. The amount of variation may be caused by the measurement system and differences between parts. The variation of the measurement system is divided into two components: repeatability and reproducibility. Repeatability is the variability from repeated measurements of the same part by the same operator. Reproducibility is the variability from repeated measurements of the same part by different operators. Two graphs were generated from the data discussed above: a graph showing the percent study variation and a graph showing the percent of variance per tolerance. A lower value for either the percent study variation or the percent of variance per tolerance indicates a higher repeatability and reproducibility of the gauge.

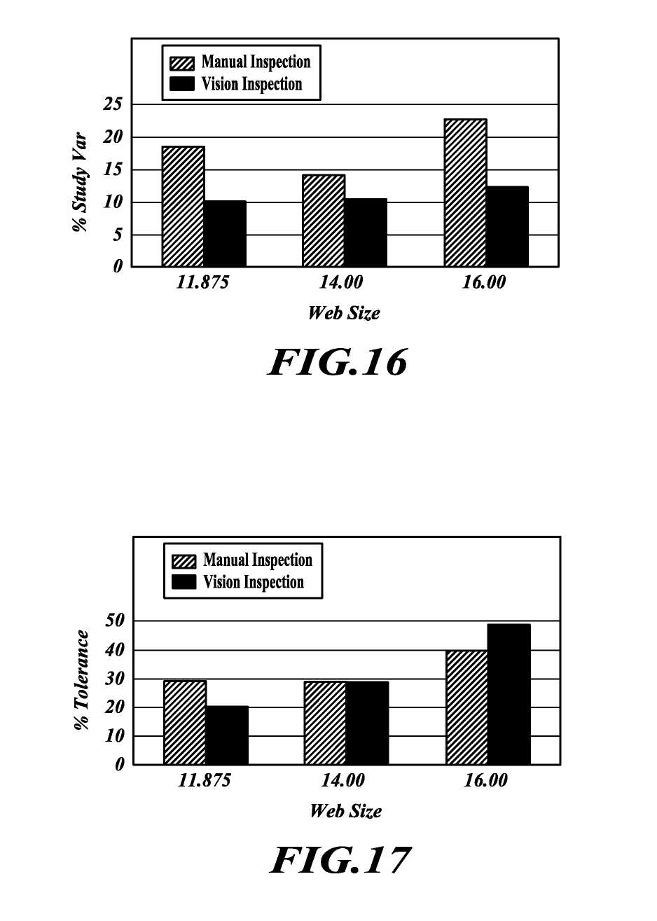

FIG. 16 is a graph depicting the percent study variation for each measurement method. Percent study variation compares the contribution of each component to the total variation. FIG. 16 shows that for all three web sizes, the percent study variation for the manual inspection method was higher than the percent study variation for the inspection method according to embodiments of the disclosure. This indicates that systems and methods according to the disclosure are more repeatable and reproducible than manual inspection methods.

FIG. 17 is a graph depicting the percent of variance per tolerance for each measurement method. Percent of variance per tolerance is the total amount of variance in the system divided by the tolerance for that dimension. For example, if the total variance in the measurement is 0.01 and the tolerance zone for the dimension is ±0.1 (a total tolerance of 0.2), the percent of variance per tolerance is 0.01 divided by 0.20 or 50%. FIG. 17 shows that for two model web sizes, the percent of variance per tolerance for the manual inspection method was higher than the percent of variance per tolerance for the inspection method according to embodiments of the disclosure. In one case (the large web case), the percent of variance per tolerance for the manual inspection method was lower.

In summary, FIGS. 16 and 17 demonstrate that systems and methods according to the disclosure are at least equivalent to manual inspection methods in terms of repeatability and reproducibility. In some embodiments, systems and methods according to the disclosure may be more repeatable and/or reproducible than manual inspection techniques. Because systems and methods according to the disclosure do not involve human intervention or stopping the production line, there may be a benefit associated with replacing manual inspection methods with inspection methods according to embodiments of the disclosure.

I/we claim:

1. A system for inspecting a manufactured composite component comprising:
a first camera assembly comprising:
a first machine vision camera mounted on a fixture, the first machine vision camera having a first field of view; and
a first lighting system operably connectable to the fixture;
a second camera assembly comprising:
a second machine vision camera mounted on the fixture a distance apart from the master machine vision camera, the slave machine vision camera having a second field of view;
a second lighting system operably connectable to the fixture; and
an image processor;
wherein the image processor is configured to process a first image taken with the first machine vision camera and a second image taken with the second machine vision camera to obtain measurements of features on the manufactured composite component, the features being selected from the group consisting of dimensions, notches, grooves, bevels, and tapers.

2. The system of claim 1 wherein the features are located within the first field of view, within the second field of view, or between the first field of view and the second field of view.

3. The system of claim 1 wherein the features are located on two or more non-parallel planes on the manufactured composite component.

4. The system of claim 1 wherein the features are not the same focal length from the first camera or the second camera.

5. The system of claim 1 wherein the first image is an image of a first end of the manufactured composite component and the second image is an image of a second end of the manufactured composite component, the first end being opposite to the second end.

6. The system of claim 1, further comprising:
a first lens connected to the first machine vision camera; and
a second lens connected to the second machine vision camera.

7. The system of claim 1 wherein the first lens is a telecentric lens and the second lens is a telecentric lens.

8. The system of claim 1, further comprising a drive assembly configured to move the manufactured composite component into the first field of view and into the second field of view.

9. The system of claim 1 wherein the first lighting system and the second lighting system each comprise:
a back light; and
a spot light.

10. The system of claim 9, further comprising:
a first light filter coupled to the first lens; and
a second light filter coupled to the second lens;
wherein the first light filter and the second light filter are configured to filter ambient light produced from the back light and the spot light.

11. A system for inspecting a composite object comprising:
a first machine vision camera positioned at a first end of an inspection assembly, the first machine vision camera having a first field of view;
a second machine vision camera positioned a fixed distance away from the first machine vision camera at a second end of the inspection assembly, the second machine vision camera having a second field of view;
a first telecentric lens operably connected to the first machine vision camera;
a first light filter connected to the first telecentric lens;
a second telecentric lens operably connected to the second machine vision camera;
a second light filter connected to the second telecentric lens;
a lighting system operably connectable to the inspection assembly, the lighting system comprising:
one or more back lights; and
one or more spot lights;
a triggering mechanism; and
a drive assembly for moving the composite object through the first field of view and the second field of view;
wherein the first machine vision camera and the second machine vision camera are connected to an image processor, the image processor configured to measure features on the composite object, the features being selected from the group consisting of dimensions, notches, grooves, bevels, and tapers.

12. The system of claim 11 wherein the composite object is a wood or wood composite.

13. The system of claim 11 wherein the composite object is a tenon for construction of a truss or a joist.

14. The system of claim 11 wherein the composite object has multiple sides and the features are located on two or more sides of the composite object.

15. The system of claim 11 wherein the features are located on two or more non-parallel planes on the composite object.

16. A method for inspecting a composite component having a first end and a second end, the method comprising:
moving the composite component through an inspection assembly, the inspection assembly comprising:
a first machine vision camera having a first field of view; and
a second machine vision camera having a second field of view; and
illuminating the composite component;
acquiring a first image of a first portion of the composite component with the first machine vision camera;
acquiring a second image of a second portion of the composite component with the second machine vision camera;
processing the first image and the second image to measure features on the composite component, the features being selected from the group consisting of dimensions, notches, grooves, bevels, and tapers.

17. The method of claim 16, further comprising processing the first image and the second image to measure features within the first field of view, features within the second field of view, and features between the first field of view and the second field of view.

18. The method of claim 16 wherein the step of moving the composite component through the inspection assembly is completed within less than about 400 milseconds.

19. The method of claim 16 wherein the step of illuminating the composite component is performed by a lighting system, the lighting system comprising:
one or more back lights; and
one or more spot lights.

20. The method of claim 16 wherein the composite component is a wood composite selected from the group consisting of oriented strand board, oriented strand lumber, laminated strand lumber, and parallel strand lumber.
